(19) United States
(12) Patent Application Publication
(10) Pub. No.: US 2014/0103129 A1
(43) Pub. Date: Apr. 17, 2014

(54) Cup Holder Integrated With Heating System In A Motor Vehicle

(71) Applicants: Alok Kumar Ray, Maharashtra (IN); Karimuddin Khan, Maharashtra (IN); R. Vinayakram, Maharashtra (IN)

(72) Inventors: Alok Kumar Ray, Maharashtra (IN); Karimuddin Khan, Maharashtra (IN); R. Vinayakram, Maharashtra (IN)

(21) Appl. No.: 13/878,961

(22) PCT Filed: Oct. 11, 2011
(86) PCT No.: PCT/IN11/00708

§ 371 Date: Jan. 2, 2014

(30) Foreign Application Priority Data
Oct. 11, 2010 (IN) 2818/MUM/2010

(51) Int. Cl. B60N 3/10; B60H 1/20

(52) U.S. Cl. CPC B60N 3/104; B60H 1/20
USPC 237/12.3 C

(57) ABSTRACT

A cup holder/heater plate integrated with heating system in a motor vehicle using exhaust gas heat for heating food/drink items. The heating system has a cup holder/heater plate provided in the console of the vehicle with a heater coil tube at bottom of said cup holder/heater plate. A fluid reservoir having inlet connected to the one end of the heater coil to receive cold fluid and outlet of the reservoir connected to the first inlet of a circulating pump for pumping cold fluid through a first outlet of the said pump to one end of the heating coil tube/heat exchanger around the exhaust manifold with other end of the said heating coil/heater plate coil connected to the second inlet of the pump for circulation of heated fluid through the second outlet of the pump to the the heater coil tube. The pump having a controller for controlling the circulation of the fluid.

### FIELD OF THE INVENTION

The present invention is related to cup holder of an automotive vehicle integrated with heating system. More particularly the present invention is related to cup holder integrated with heating system in a motor vehicle wherein exhaust heat is recovered and used as the source for heating.

### BACKGROUND OF THE PRESENT INVENTION

During vehicle running, the customer is not having any facility to drink hot coffee and/or hot water for his refreshment or to meet the infant needs. The customer has to stop somewhere and then have to look for hot water, milk or coffee. The basic idea is to provide a heat source and mechanism therefore inside the vehicle compartment so that the customer can do all the work requiring heating, inside the car and that too during vehicle running condition.

The method of heating fluids using an exhaust heat recovery is the basic concept of this mechanism. The exhaust heat of the vehicle is around 800 deg Celsius. This heat can be used to heat or boil the water at 100 deg Celsius.

Normally exhaust heat recovery for power generation is done in gas turbines which are used to run the turbine again. Similar kind of waste heat recovery is not done in automobiles.

### STATEMENT OF THE INVENTION

Accordingly invention provides a cup holder with heater plate integrated with heating system in a motor vehicle using exhaust gas heat for heating food/drink items comprises a cup holder/heater plate provided in the console of the vehicle with a heater coil tube at bottom of said cup holder/heater plate; a fluid reservoir having inlet connected to the one end of the said heater coil to receive cold fluid and outlet of the said reservoir connected to the first inlet of a circulating pump for pumping cold fluid through first outlet of the said pump to one end of heating coil tube/heat exchanger around the exhaust manifold with other end of the said heating coil/heater plate coil connected to the second inlet of the said pump for circulation of heated fluid through the second out let of the said pump to the said heater coil tube; the said pump having controlling means for pumping in such way that fluid from reservoir pumped for heating and after heating heated fluid is pumped to heater coil tube till heater service and thereafter cold fluid pumped back to reservoir.

### DESCRIPTION OF THE FIGURES

FIG. 1 shows block diagram of cup holder with heating system in accordance with the present invention.

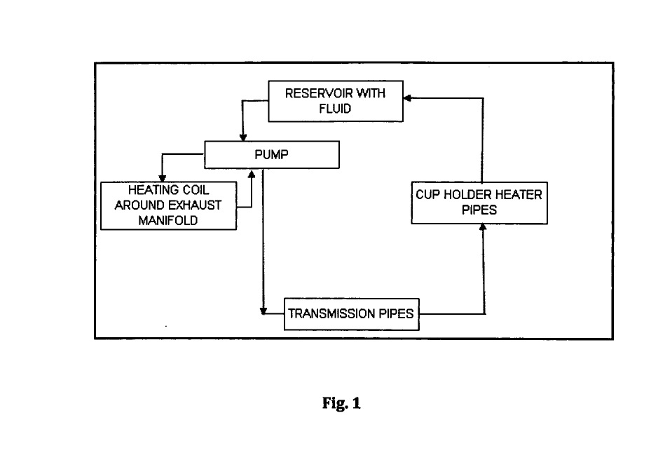

FIG. 2 shows schematic diagram of heat recovery system in accordance with the present invention.

FIG. 3 shows the sectional view of cup holder integrated with heating system.

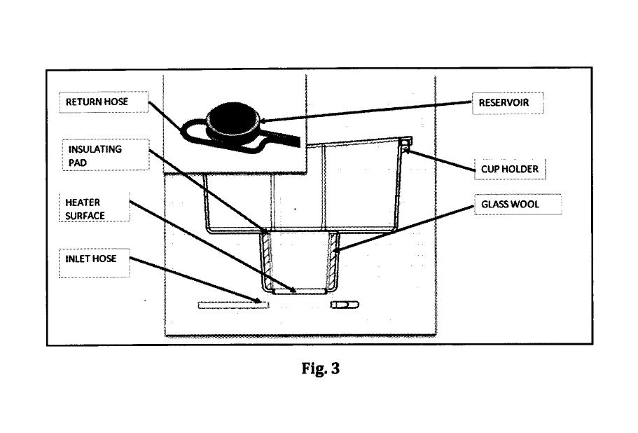

FIG. 4 shows the sectional view of fluid transmission tube with the insulation as per the present invention.

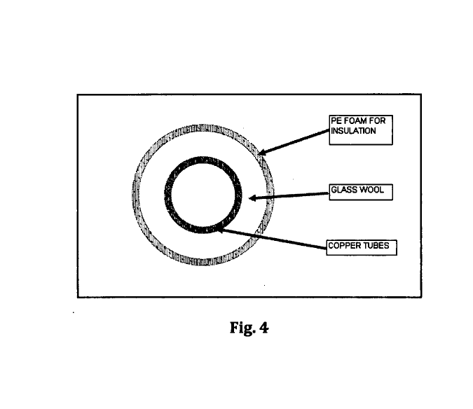

### DETAILED DESCRIPTION OF THE PRESENT INVENTION

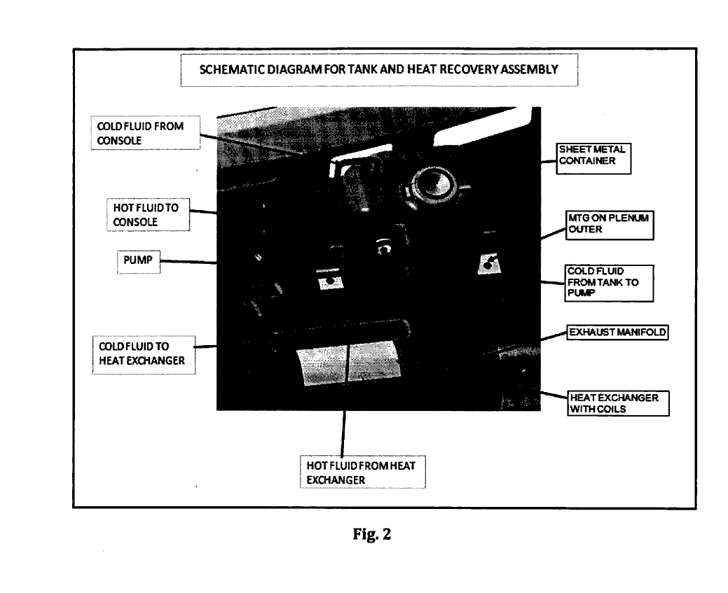

Referring to FIG. 2, the heating system of the invention comprises of sheet metal container, pump, heat exchanger with coils and fluid conveying tubes. The sheet metal container works as the reservoir for fluid which is the heat transfer media and is mounted on the plenum outer of the vehicle with the help of mounting brackets. The heat exchanger is having the coiled tubing wherein the heat transfer fluid is circulated and the whole assembly is mounted on the exhaust manifold of the engine.

As per the present invention, the fluid in the reservoir will be oil which can withstand heat up to approx. 300 deg Celsius. The reservoir will be placed in the plenum outer by using two bolts and will be connected to the pump in the same location. The steel tank is connected to the pump through the fluid conveying tubing and the whole assembly is placed beside the front wiper mechanism. The fluid from the reservoir will then go to the coils of the heat exchanger near the exhaust manifold.

The exhaust manifold is having exhaust air which passes with 800 deg Celsius heat. This waste heat is used to heat the oil in the reservoir in a close loop system. The heat exchange happens by the means of a coil type heat exchanger. This heat exchanger transmits the heat to the oil and the oil is heated up to approx. 125 deg Celsius. This fluid is then transferred to the center console through the dash panel by the insulated routing of the oil conveying tubing.

The heated oil by the heat exchanger is transferred to the heating coils placed beneath the cup holder or heater plate in the center console of a vehicle. The number of coils and the speed of the pump decide the rate at which the cup will get heated. After the oil transfers the heat to the plate and then the oil returns back to the reservoir. This is a cycle wherein the oil is circulated in a close loop system and this is done till the customer switches off the pump. After the heating is over the pump is actuated to evacuate the oil and returned back to the sump. During non operation of the heating system, the fluid is not heated and hence the passenger compartment does not have that much of heat inside it. The oil conveying tubes are fitted on the vehicle body using C clamps.

The Cup holder in the center console is designed in such a way that it does not injure the passengers when accessing the cup holder. The heater is placed only at the bottom surface and insulated by glass wool on the sides. There is another insulating pad in the form of cup which will protect the user from touching the hot pads. The insulation is done on the bottom side also to ensure that the heat generated does not melt the plastic center console.

The pipes used for transmitting oil are made of copper and covered by glass wool which acts as an insulator. These tubes are routed from the plenum outer to the center console through the dash panel assembly. These tubes are clamped to the body panel by C clamps. The heat exchanger is fixed on the exhaust manifold by bolts.

The present invention of cup holder with integrated heating system can cater the user to heat water or milk during running condition of the vehicle. This option will be available even without any use of battery power and heater coils.

### Advantages of the Present Invention

The present invention has following advantages.
1. The battery power is saved due to the elimination of power from battery.
2. Exhaust heat from the vehicle is utilized.
3. The heating system can be put ON only when it is required.
4. The waste fluid is again pumped to the reservoir so that the oil does not remain hot all ways.
5. The tank will be packaged in the plenum outer and dash area adjacent to the windscreen wiper mechanism
6. Easy to replace and fill the oil.
7. The tubes are insulated using glass wool and PE coatings.
8. Heat is not transferred to the engine compartment because of the tubes.
9. AC is not affected by this heater.
10. Very less power consumption for the pump actuation.

1. A cup holder/heater plate integrated with a heating system in a motor vehicle using exhaust gas heat for heating food/drink items, comprising:
a cup holder/heater plate provided in a console of the vehicle with a heater coil at a bottom of said cup holder/heater plate;
a fluid reservoir having an inlet and an outlet, the inlet connected to one end of the heater coil to receive cold fluid, and the outlet connected to a first inlet of a circulating pump for pumping cold fluid through a first outlet of the circulating pump to one end of a heating coil tube/heat exchanger positioned at an exhaust manifold with another end of the heating coil tube heat exchanger connected to a second inlet of the circulating pump for circulation of heated fluid through the second outlet of the pump to the heater coil; the pump having controlling means for pumping such that fluid pumped from the reservoir to the cup holder/heater plate for heating the cup holder/heater plate, and after heating the cup holder/heater plate, heated fluid is pumped back to the reservoir.

2. The heating system as claimed in claim 1, wherein the reservoir is attached to a plenum outer by using two or more bolts.

3. The heating system as claimed in claim 1 wherein the fluid is oil.

4. The heating system as claimed in claim 1 wherein the heater coil tube, and heating coil tube are made of copper.

5. The heating system as claimed in claim 1 wherein the said tube connected to the reservoir, pump, heating coil tube, and heater coil are insulated by glass wool.

6. The heating system as claimed in claim 2 wherein the fluid is oil.

7. The heating system as claimed in claim 3 wherein the heater coil tube, and heating coil tube are made of copper.

8. A heating system as claimed in claim 2 wherein the tube connected to the reservoir, pump, heating coil tube, and heater coil are insulated by glass wool.
